(19) United States
(12) Patent Application Publication
(10) Pub. No.: US 2007/0182352 A1
(43) Pub. Date: Aug. 9, 2007

(54) Method and circuit arrangement for the electrical control and/or regulation of the movement of an electrically driven unit

(75) Inventors: Thomas Oxle, Markdorf (DE); Wolfgang Schulter, Meersburg (DE)

Correspondence Address: CONTINENTAL TEVES, INC., ONE CONTINENTAL DRIVE, AUBURN HILLLS, MI, 48326-1581, US

(73) Assignee: Conti Temic Microelectronic GMBH

(21) Appl. No.: 11/579,746

(22) PCT Filed: Feb. 12, 2005
(86) PCT No.: PCT/DE05/00244

§ 371 Date: Nov. 8, 2006

(30) Foreign Application Priority Data
May 8, 2004 (DE) 10 2004 022 807.8

(51) Int. Cl. H02P 3/00

(52) U.S. Cl. 318/453

(57) ABSTRACT

A method for electrical control and/or regulation of the movement of an electrically-driven unit, in particular, a window winder for a sunroof of a motor vehicle, is disclosed. A correlation parameter for the operating force of the unit is measured for trapping protection and a switching off or reversing of an operating movement is carried out as trapping protection, when the correlation parameter for the operating force exceeds a threshold value which corresponds to a given trapping force. A filter for temporal filtering of the correlation parameter for the operating force of the unit is provided, whereby the filter is deactivated in the presence of given operating conditions. According to the invention, the decision on the activation and deactivation of the filter is achieved, depending on an alternating signal fraction of the measured correlation parameter, or another parameter proportional thereto. The motor current is preferably recorded as the correlation parameter for the operating force and a decision is made, based m on a parameter characterising the size of the alternating current fraction and/or a parameter characterising the size of the alternating voltage fraction and/or a parameter characterising the rotational speed of the rotor, as to whether the directly detected motor current signal or the filtered motor current signal is used for calculation of the operating force.

### BACKGROUND OF THE INVENTION

The method and the circuit arrangement refer to the recognition of jamming situations with electrically driven units or adjusting drives in motor vehicles, such as window winders, sunroofs or seat adjustment devices.

There are various regulations and directives that refer to such adjusting drives, for example European Community Directive 74/60/EEC by the European Union, EC21 by the United Nations Economic Commission for Europe (UNECE), FMVSS118 by the National Highway Traffic Safety Administration of the USA etc. All these regulations require limiting the jamming force to a maximum of 100 Newton in the presence of certain operating and test conditions.

From DE 44 42 171 A1, a method is known in which, for the recognition of jamming situations, the performance parameters of the electric motor are continuously picked up at measuring instants that are equidistant in time, and the adjusting force is determined therefrom.

Usually, brush-commutated d.c. motors with two magnetic poles are used in adjusting drives of motor vehicles. Commutation results in so-called current ripples on the motor-current signal, wherein a ripple occurs with each commutation.

In addition, the voltage of the electrical supply system of a motor vehicle also comprises alternating components when certain operating conditions prevail. These alternating components of the motor voltage cause additional alternating components in the motor current.

According to the general state of the art, a continuous signal is low-pass-filtered prior to equidistant-in-time sampling, wherein the limit frequency of the low-pass filter is lower than half of the sampling frequency. According to well-known Shannon's sampling theorem, this is necessary in order to prevent so-called aliasing effects. Usually, the utilized motors comprise between 8 and 12 slots so that 10 current ripples per revolution occur in a 10-slot motor. Thus, an alternating-current signal with a frequency of 10 times the speed superposes on the motor-current signal. Depending on the load and the operating voltage, the speed of the rotor is typically between 10 and 80 revolutions per second. Thus, the alternating components in the motor current caused by commutation are within a frequency range of between 100 and 800 Hz.

Typically, the motor current variations caused by jamming situations are within a frequency range of less than 20 Hz.

Usually, the components caused by commutation are suppressed by means of a low-pass arrangement that also suppresses the higher-frequency components of the alternating components in the motor current caused by ripples in the voltage of the electrical supply system of the vehicle. For example, it is necessary to select a limit frequency of the low-pass filter of significantly lower than 100 Hz in order to sufficiently damp current ripples at 100 Hz.

In a jamming situation, the adjusting force increases which causes an increase in motor current. As shown in FIG. 2, low-pass filtering disadvantageously causes a delayed increase in filtered current which in the end results in a delayed recognition of jamming situations and thus in increased jamming forces.

Since the alternating components are very big in the presence of certain operating conditions, a very high degree of suppression is usually selected within the frequency range of the disturbing alternating components. This is achieved either by using appropriately low limit frequencies or by using appropriately high filter orders. However, low limit frequencies and high filter orders disadvantageously increase delay times.

The object of the invention is to provide a method and a circuit arrangement for the control and/or regulation of the movement of an electrically driven unit with jamming protection with lowest possible jamming forces and at the same time sufficient robustness with regard to disturbances.

### SUMMARY OF THE INVENTION

According to the invention, this object is achieved, regarding the method, by a method for the electrical control and/or regulation of the movement of an electrically driven unit (2), in particular of a window winder or a sunroof or a seat adjustment device of a motor vehicle, in which a correlation quantity (K) for the adjusting force of the unit (2) is determined and, in order to prevent jamming, an adjusting movement of the unit (2) is stopped or reversed depending on the value of the correlation quantity (K), wherein the correlation quantity (K) is temporarily filtered and, regarding the circuit arrangement for the electrical control of the movement of an electrically driven unit (2), in particular of a window winder or a sunroof or a seat adjustment device of a motor vehicle, comprising an acquisition unit (1) for measuring a correlation quantity (K) for the adjusting force of the unit (2) and an adjusting device (300) for stopping or reversing an adjusting movement of the unit (2) depending on the value of the correlation quantity (K) in order to prevent jamming, wherein a filter arrangement (100) for the temporary filtering of the correlation quantity (K) is arranged between the acquisition unit (1) and the adjusting device (300).

In order to provide a method for operating the unit or an adjusting drive that takes into consideration the respective situation and provides best possible jamming protection, a correlation quantity for the adjusting force of the unit is determined and the adjusting movement of the unit is stopped or reversed depending on the value of the correlation quantity, wherein the correlation quantity is temporarily filtered. In particular, temporary filtering of the correlation quantity comprises situation-dependent filtering of the correlation quantity and/or its filtering for a predeterminable limited period during the operation of the electrically driven unit. In other words: A filtered or an unfiltered correlation quantity is used as an input quantity for the recognition of a jamming situation with the electrically driven unit or drive, whereby, in the presence of certain, particularly predeterminable conditions, the filter-caused time-delayed recognition of a jamming situation is avoided by using the unfiltered correlation quantity. In this way, lower jamming forces are achievable, in particular at high adjusting speeds and also in situations where very hard objects are jammed. In addition, in order to recognize jamming situations caused by tripping the unit, a filtered or an unfiltered correlation quantity is used depending, for example, on a quantity characterizing the intensity of the alternating-signal components of the correlation quantity and/or a quantity characterizing the ripples in the voltage of the electrical supply system of the vehicle and/or a quantity characterizing the speed of the unit.

For example, a motor-current signal of the adjusting motor or rotor that brings about the adjusting force of the window winder or of the sunroof is used as a correlation quantity for the adjusting force with a window winder or a sunroof. Alternatively or in addition, the speed of the unit or of the adjusting motor and/or the voltage of the electrical supply system of the vehicle and/or the electrical resistance and/or the inductance of the unit and/or the temperature (i.e. unit temperature) and/or a machine or unit constant and/or the magnetic flux and/or a characteristic of the unit is/are used for calculating the correlation quantity in these cases of application.

In another embodiment, a quantity characterizing the intensity of the ripples in the voltage of the electrical supply system of the vehicle is determined on the basis of the speed of the vehicle, the state of the vehicle drive engine and/or the speed of the vehicle drive engine. It is also possible to use the state of the vehicle ignition system and/or an ignition key inserted in the ignition lock for determining a quantity characterizing the intensity of the ripples in the voltage of the electrical supply system of the vehicle.

An alternating-signal component of the determined correlation quantity is suitably determined, and the decision on the activation and deactivation of the filter is made depending on this alternating-signal component. In other words: By means of the correlation quantity, the filter is controlled (i.e. activated or deactivated) on the basis of one of these characteristic features, e.g. an alternating-signal component. In addition, the filter may be activated or deactivated in the presence of a predetermined operating condition of the unit and/or the vehicle, e.g. at a standstill of the vehicle or at a predetermined vehicle speed.

Preferably, the decision as to whether directly use the determined and unfiltered correlation quantity or the filtered correlation quantity for recognizing a jamming situation is made on the basis of a quantity characterizing the intensity of the alternating-signal components of the correlation quantity and/or the quantity characterizing the intensity of the ripples in the voltage of the electrical supply system of the vehicle and/or the quantity characterizing the speed of the unit or of the drive engine.

Preferably, the intensity of the alternating-signal components is determined on the basis of the amplitude and/or the function of the high-pass-filtered input signal. For example, the maximum value of a predetermined number of high-pass-filtered measured or input values of the input signal is determined for determining the amplitude. For example, the mean power of a predetermined number of high-pass-filtered or band-pass-filtered input values is determined for determining the function.

The circuit arrangement for the electrical control and/or regulation of the movement of an electrically driven unit comprises an acquisition unit for determining a correlation quantity for the adjusting force of the unit, and an adjusting device for stopping or reversing an adjusting movement of the unit depending on the value of the correlation quantity in order to prevent jamming, wherein a filter arrangement for the temporary filtering of the correlation quantity is arranged between the acquisition unit and the adjusting device. In a simplest possible embodiment of the filter arrangement, a controllable filter is provided for the temporary filtering of the correlation quantity, wherein the controllable filter is activated or deactivated by means of an output signal of a threshold comparator.

In a possible embodiment for the indirect control of the filter, a switch is actuated by means of the output signal of the threshold comparator, said switch supplying the adjusting device with the correlation quantity filtered by means of the filter or with the unfiltered correlation quantity. For controlling the switch, the threshold comparator is supplied with, for example, the correlation quantity and/or the alternating-signal components of the correlation quantity and/or the speed of the adjusting motor and/or a quantity characterizing the ripples in the voltage of the electrical supply system of the vehicle.

The particular advantage of the invention is that delayed identification of a jamming situation is reliably avoided by controllably filtering jamming-relevant quantities on the basis of the controllable filtering of a correlation quantity. Moreover, a jamming situation is immediately and thus quickly and easily identified by controlling the filtering process, in particular by deactivating the filtering of the correlation quantity.

### BRIEF DESCRIPTION OF THE DRAWINGS

In the following, the invention will be described on the basis of exemplary embodiments and figures. The figures show:

FIG. 1 Time history of the motor-current signal of a unit, e.g. an adjusting

i. motor, at low load and high speed;

FIG. 2 Time history of the motor-current signal at higher load and low speed;

FIG. 3 Time history of the motor-current signal in a jamming situation (signal A)

i. as well as time history of the motor-current signal filtered with a first

ii. order low-pass filter (signal B) in a jamming situation;

FIG. 4 Schematic representation of a circuit arrangement for the control and/or

i. regulation of the unit, e.g. of an adjusting motor, with an acquisition unit for a jamming-relevant quantity and an adjusting device for the unit and a filter arrangement arranged between the acquisition unit and the adjusting device considering the directly measured unit speed;

FIG. 5 Schematic representation of another embodiment of a circuit

i. arrangement for the control and regulation of the unit with an acquisition unit for a jamming-relevant quantity and an adjusting device for the unit and a filter arrangement arranged between the acquisition unit and the adjusting device without directly measuring the unit speed;

FIG. 6 Detailed schematic representation of a filter arrangement; and

FIG. 7 Schematic representation of a detail of the filter arrangement.

### DETAILED DESCRIPTION OF THE DRAWINGS

The same reference numerals will be used throughout the figures to refer to similar parts.

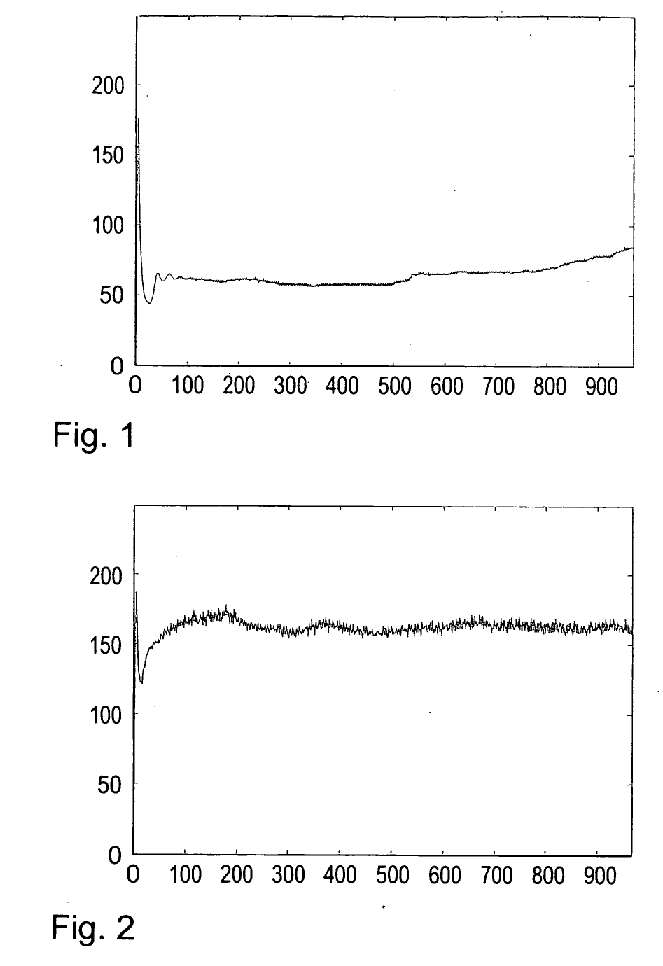

FIG. 1 shows a time history of a motor-current signal I of a unit, e.g. of an adjusting motor for a window winder or for a sunroof, at low load and high speed. As can be seen, the intensity of the current ripples is very small. FIG. 2 shows a time history of the motor-current signal I at higher load and low speed. As can be seen, the intensity of the current ripples is much bigger than the intensity of the current ripples according to FIG. 1.

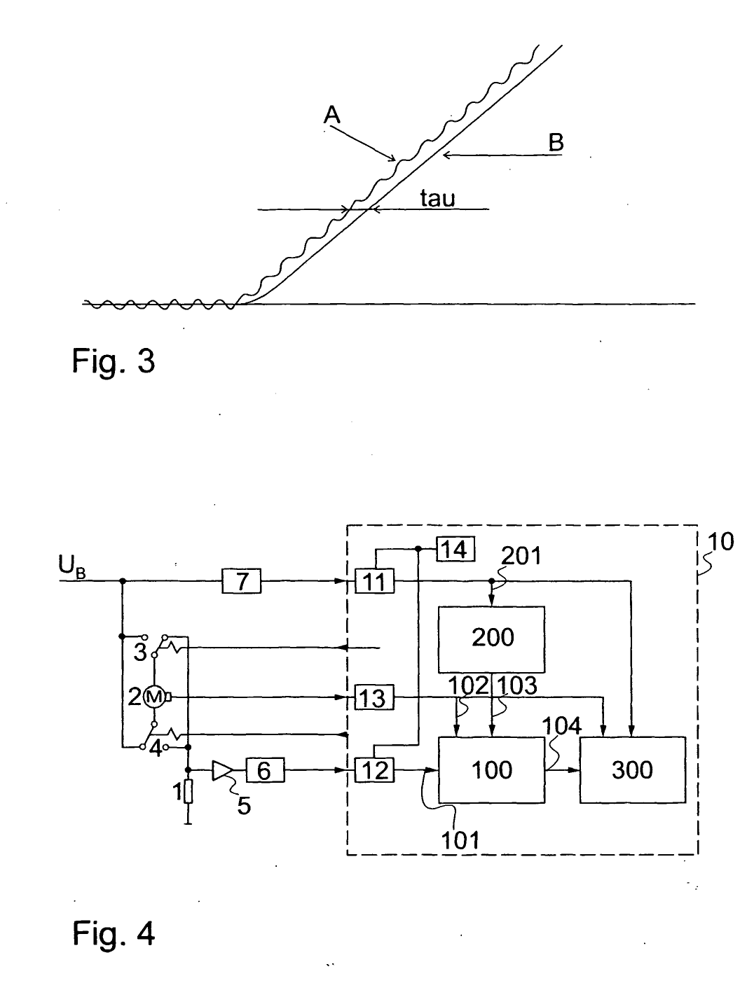

FIG. 3 shows a time history of an unfiltered motor-current signal I_{A} in a jamming situation (signal A) as well as a time history of a motor-current signal I_{B} filtered with a first-order low-pass filter (signal B) in a jamming situation. The time-delayed rise (caused by the filtering process) of the filtered motor-current signal I_{B} is apparent.

The first-order filter is defined by transfer function H:

$$a . H ( f ) = \frac{k}{l + j \frac{f}{fg}} \qquad [ 1 ]$$

where k is the factor of proportionality, f is the frequency, and f_{g} is the limit frequency. The indicated delay time τ (=tau) is defined by the following formula:

$$a . τ = \frac{1}{2 * π * fg} \qquad [ 2 ]$$

In the following, a circuit arrangement 1 for the electrical control and/or regulation of the movement of an electrically driven unit 2, e.g. an adjusting motor for a window winder or a sunroof, will be described in greater detail on the basis of FIGS. 4 to 7.

FIG. 4 is a block diagram showing a part of a drive control system or of the circuit arrangement SA.

The circuit arrangement SA comprises an acquisition unit 1 for picking up the motor-current signal I for the adjusting force of a unit 2, e.g. of an adjusting or drive motor M. For example, the acquisition unit 1 may be a resistor for determining the motor-current signal I of unit 2. Two relays 3 and 4 are provided for driving the motor of unit 2.

An amplifier 5, in particular a signal amplifier for amplifying the input signal (i.e. motor current I) is provided for taking into consideration the correlation quantity K when determining the adjusting force of unit 2. A low-pass filter 6 is connected downstream the amplifier 5 in order to avoid aliasing effects during subsequent sampling of the motor-current signal I.

The circuit arrangement SA picks up, in addition to motor current I, the voltage U_{B} of the electrical supply system of the vehicle. A low-pass filter 7 is provided for avoiding aliasing effects during the subsequent sampling of the voltage U_{B} of the electrical supply system of the vehicle.

Afterwards, the voltage U_{B} of the electrical supply system of the vehicle and the motor-current signal I are supplied to a drive control system 10 of the circuit arrangement SA for the control and/or regulation of unit 2. In addition or alternatively, the speed n of unit 2 may be picked up and supplied to the drive control system 10.

For sampling the signals picked up, i.e. the voltage U_{B} of the electrical supply system of the vehicle and/or the motor current I, the drive control system 10 comprises a sampling element 11 and a sampling element 12, respectively. Moreover, a clock generator 14 connected to the sampling elements 11 and 12 is provided for generating sampling clock pulses. The drive control system 10 comprises an acquisition unit 13 for picking up the speed n of unit 2.

For determining the adjusting force of unit 2, the drive control system 10 comprises, on the one hand, a filter arrangement 100 and an adjusting device 300 connected downstream the filter arrangement 100 for recognizing a jamming situation and controlling the unit 2 accordingly. On the other hand, for determining the alternating-signal components of the voltage U_{B} of the electrical supply system of the vehicle, the sampling element 11 is connected to a further acquisition unit 200 for determining the ripples in the voltage of the electrical supply system of the vehicle, wherein the filter arrangement 100 serves to filter the correlation quantity K, in particular the motor-current signal I, and thus to filter the current in order to suppress alternating-signal components caused by commutation and by disturbances in the electrical supply system of the vehicle. The filter arrangement 100 is connected between the acquisition units 1, 13 and/or 200 and the adjusting device 300.

Depending on the type and the configuration of the drive control system 10, a further module 100a for forming and determining the correlation quantity K may be connected preceding the filter arrangement 100. For example, the correlation quantity K may also be determined on the basis of at least one of the following parameters or on the basis of several parameters P1 to Pn. As parameters P1 to Pn serve, for example, the voltage U_{B} of the electrical supply system of the vehicle, the electrical resistance and/or the inductance of unit 2, the temperature and/or a machine constant of unit 2, the magnetic flux and/or a characteristic of unit 2. A correlation quantity K determined in such an indirect way is supplied as an unfiltered correlation quantity 101 to the filter arrangement 100.

During the operation of the drive control system 10, the voltage U_{B} of the electrical supply system of the vehicle is supplied as a sampled signal 201 of the voltage of the electrical supply system of the vehicle to the acquisition unit 200 for determining the ripples in the voltage of the electrical supply system of the vehicle and to the adjusting device 300. On the basis of the signal 201 of the voltage of the electrical supply system of the vehicle and/or further operating signals (e.g. the state of the ignition system, the state of the vehicle drive engine, the speed of the vehicle drive engine and/or the travelling speed), the acquisition unit 200 determines a signal 103 characterizing the intensity of the alternating-voltage components. The signal 103 is supplied to the filter arrangement 100.

A quantity 102 characterizing the speed n of the rotor or of unit 2 is also supplied to the filter arrangement 100. On the basis of the quantity 102 characterizing the speed n and of the signal 103 characterizing the intensity of the alternating-voltage components as well as on the basis of the sampled motor-current signal I and the unfiltered correlation quantity 101 resulting therefrom, a control signal 104 is determined by means of the filter arrangement 100. The control signal 104 is supplied to the adjusting device 300 for recognizing a jamming situation of unit 2. Thus, the filter arrangement 100 is controllable, i.e. a filtered correlation quantity 141 or an unfiltered correlation quantity 101 is supplied to the adjusting device 300 as a control signal 104 depending on the signals 101, 102 and/or 103 supplied to the filter arrangement 100, as illustrated in FIG. 6 in greater detail.

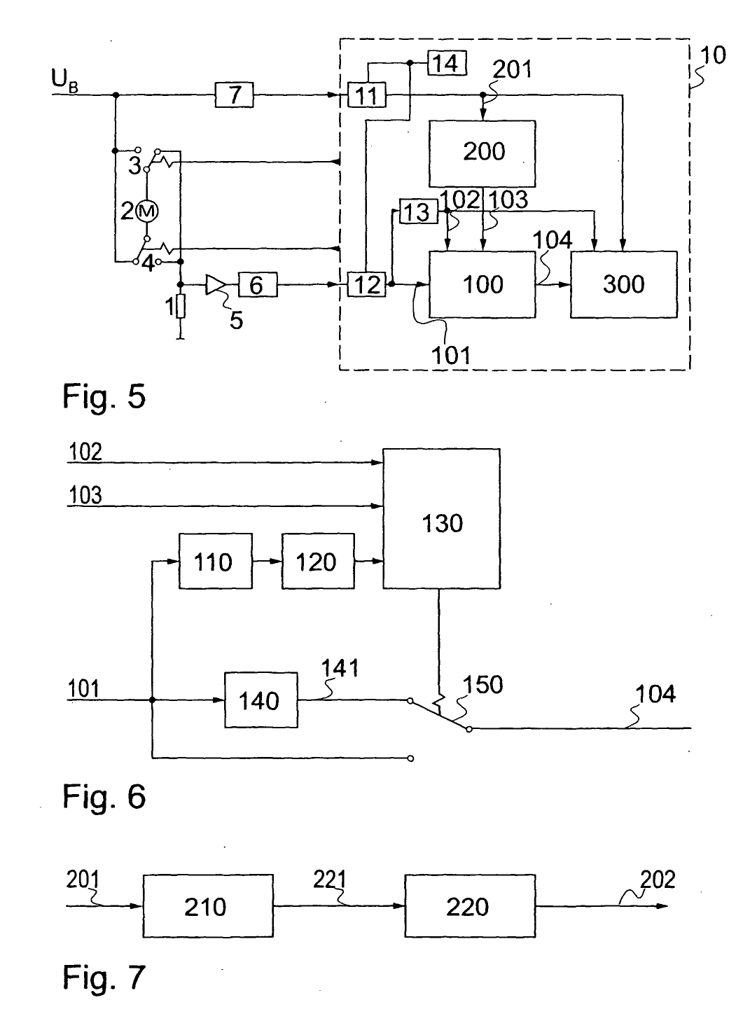

FIG. 5 is a block diagram showing an alternative embodiment for a circuit arrangement SA, wherein the speed n of unit 2 is determined from the current ripples of the motor-current signal I by means of the acquisition unit 13. For this purpose, the input of the acquisition unit 13 is connected to the output of the sampling element 12 for the sampled motor-current signal 101.

FIG. 6 is a detailed representation of the filter arrangement 100 for filtering the unfiltered correlation quantity 101. For example, the motor-current signal I, in particular the sampled motor-current signal I or a correlation quantity K determined on the basis of the parameters P1 to Pn (e.g. the voltage U_{B} of the electrical supply system of the vehicle, the electrical resistance, the inductance and/or the temperature and/or other parameters of the unit), is supplied as an unfiltered correlation quantity 101 to the filter arrangement 100. In addition, a signal 102 characterizing the speed n of the rotor or of unit 2 and/or the signal 103 characterizing the intensity of the alternating-voltage components of the voltage U_{B} of the electrical supply system of the vehicle is/are supplied to the filter arrangement 100.

For example, the sampled motor-current signal 101 is directly used as the correlation quantity K. For this purpose, the sampled motor-current signal 101 is supplied to an alternating-current filter 110 for filtering and determining the alternating-signal components, in particular the alternating-current components of the sampled motor-current signal 101. For example, the alternating-current filter 110 is a high-pass or a band-pass filter. An intensity-measuring device 120 for determining the intensity of the alternating-current components is connected downstream the alternating-current filter 110. For example, the amplitude, e.g. the maximum value of a certain number of input values, or a function, e.g. the mean power or the amplitude mean value of a certain number of input values, is determined for determining the intensity of the alternating-current components. On the output side, a quantity characterizing the intensity of the alternating-current components is supplied to a threshold comparator 130.

For taking into consideration further parameters when determining a jamming situation, the signal 102 representing the speed n and the signal 103 representing the intensity of the ripples in the voltage of the electrical supply system of the vehicle are supplied to the threshold comparator 130. By means of the threshold comparator 130, these signals are processed to form a control signal SS for a switch 150 that supplies to the adjusting device 300 as the signal 104 either the correlation quantity 141 filtered by means of a filter 140 for suppressing the ripples caused by the ripples in the voltage of the electrical supply system of the vehicle and by commutation or the unfiltered, sampled correlation quantity 101, e.g. the motor-current signal I. The filter 140 is configured as a low-pass filter or a band-pass filter.

FIG. 7 illustrates an embodiment for the acquisition unit 200 for determining the ripples in the voltage of the electrical supply system of the vehicle. The acquisition unit 200 comprises an alternating-voltage filter 210 and an intensity-measuring device 220. It should be pointed out that this embodiment of the acquisition unit 200 is only one of the various possibilities disclosed in the patent of generating a signal 202 characterizing the intensity of the alternating components of the voltage U_{B} of the electrical supply system of the vehicle which signal is supplied to the filter arrangement 100 as the signal 103.

The operation of the circuit arrangement SA will now be explained in greater detail.

Determining the Disturbances in the Correlation Quantity

In a first exemplary embodiment, the disturbances in the correlation quantity K, e.g. in the motor-current signal I, are determined as follows: By means of the alternating-current filter 110 (e.g. a high-pass or band-pass filter), the disturbing alternating components are extracted from the measured motor-current signal 101, and a signal 122 characterizing the intensity of the alternating components is generated from these alternating components by means of the intensity-measuring device 120. For example, this intensity-measuring device 120 may be configured as an amplitude detector that outputs the maximum value of a certain number of measured values. It is also possible to use a wattmeter that outputs the mean power of a certain number of measured values. In a special realization of the exemplary embodiment, the sampled and unfiltered correlation quantity 101 used for this calculation is delayed for a certain number of sampling intervals.

Tests have shown that the amplitude of the alternating-signal component of the unfiltered correlation quantity 101 caused by the commutation by the brushes in the motor M depends on the amplitude of the d. c. component and on the speed n: the bigger the amplitude of the d. c. component and the smaller the speed n of the rotor, the bigger the amplitude of the alternating-signal component of the unfiltered correlation quantity 101. In a further exemplary embodiment, the signal 122 characterizing the intensity of the alternating-signal components is thus generated by multiplying the amplitude of the d. c. component by a factor of proportionality k.

In a further exemplary embodiment, the signal 122 characterizing the intensity of the alternating-signal components is generated by dividing a predetermined value by the quantity 102 characterizing the speed n of the rotor. The advantage of the two latter exemplary embodiments is that no alternating-current filter 110 and thus no high-pass or band-pass filter and no wattmeter or intensity-measuring device 120 have to be used which makes cheaper realization possible.

Determining the Disturbances in the Electrical Supply System of the Vehicle

In a further exemplary embodiment, the disturbances in the electrical supply system of the vehicle are determined as follows: By means of an alternating-voltage filter 210, the disturbing alternating-voltage components are extracted as a signal 221 from the measured signal 201 of the voltage of the electrical supply system of the vehicle, and a signal 202 characterizing the intensity of the alternating-voltage components is generated from these alternating-voltage components by means of an intensity-measuring device 220. This signal 202 is supplied to the filter arrangement as a signal 103. For example, this intensity-measuring device 220 may be configured as an amplitude detector that outputs the maximum value of a certain number of measured values. It is also possible to use a wattmeter that outputs the mean power of a certain number of measured values. In a special realization of the exemplary embodiment, the signal 201 of the voltage of the electrical supply system of the vehicle used for this calculation is delayed for a certain number of sampling intervals.

When the ignition system of a motor vehicle is switched off, only very few electric systems are active. Additional electric systems are activated by switching the ignition system on. Further electric systems, e.g. electrically driven power steering, are activated when the engine is running. All of these electric systems may cause variations in the voltage U_{B} of the electrical supply system of the vehicle. During the travel of the motor vehicle, additional variations in the voltage U_{B} of the electrical supply system of the vehicle may be caused by systems such as electric running-gear control systems. The possible occurrence of variations in the electrical supply system of the vehicle may thus be inferred from the state of the ignition system, the state of the drive engine and/or the speed of the vehicle. The advantage of the generation of a signal 103 characterizing the intensity of the alternating-voltage components in additional dependence on the state of the ignition system and/or the state of the drive engine and/or the speed of the vehicle is that no alternating-voltage filter 210 and no intensity-measuring device 220 have to be used which makes cheaper realization possible.

In a further exemplary embodiment, the signal 103 characterizing the intensity of the alternating-voltage components is thus influenced by the state of the ignition system. In the state “ON” of the ignition system, the signal 103 characterizing the intensity of the alternating-voltage components is increased by a predetermined value Z.

In a further exemplary embodiment, the signal 103 characterizing the intensity of the alternating-voltage components is influenced by the state of the drive engine of the motor vehicle. In the state “Engine is running”, the signal 103 characterizing the intensity of the alternating-voltage components is increased by a predetermined value M.

In a further exemplary embodiment, the signal 103 characterizing the intensity of the alternating-voltage components is influenced by the vehicle speed of the motor vehicle. If the vehicle speed is above a certain threshold, the signal 103 characterizing the intensity of the alternating-voltage components is increased by a predetermined value G.

In a further exemplary embodiment, the signal 103 characterizing the intensity of the alternating-voltage components is calculated by multiplying the vehicle speed by a factor of proportionality.

Determining the Quantity Characterizing the Speed of the Rotor

It should be pointed out that it is within the scope of the invention to determine the speed n of the rotor or of unit 2 from the current ripples caused by commutation (see DE 197 29 238 A1). In another exemplary embodiment, the speed n of the rotor is picked up by means of sensors that output a pulse sequence whose period correlates with the speed n. For example, such a sensor may be a Hall sensor that detects the magnetic flux of a magnetic-pole wheel arranged on the rotor axle.

Driving the Switch 150 by the Threshold Comparator

In the threshold comparator 130, the signal 122 characterizing the intensity of the alternating-signal components is compared with a threshold 71. If the signal is above this threshold, the switch 150 is moved into switch position S1, and into switch position S2 if not, wherein the threshold 71 is selected depending on the signal 103 characterizing the intensity of the alternating-voltage components and/or on the signal 102 characterizing the speed n of the rotor.

In one exemplary embodiment, the value of the threshold 71 is predetermined. In a further exemplary embodiment, the threshold 71 is set depending on the signal 103 characterizing the intensity of the alternating-voltage components. In this way it is possible to treat the cases in which the ripples in the motor current I are caused by commutation differently from the cases in which the ripples in the motor current I are caused by ripples in the voltage of the electrical supply system of the vehicle.

In a further exemplary embodiment, the threshold 71 is set depending on the signal 102 characterizing the speed n of the rotor. From a certain speed n upwards, the frequency of the ripples caused by commutation is within a range above the limit frequency of the low-pass filter 6 connected preceding the sampling stage and is thus damped by this low-pass filter 6. For this reason one can assume that the ripples in the motor current I are caused by ripples in the voltage of the electrical supply system of the vehicle from a certain speed n upwards. In this case it is advantageous to select a value for the threshold 71 that is different from the value in those cases in which the ripples are caused by commutation.

Position of Switch 150

In switch position S1, the switch 150 connects the output of the filter 140 to the input of the adjusting device 300 for recognizing a jamming situation by means of the filtered correlation quantity 141. In switch position S2, the switch 150 connects the sampled and unfiltered correlation quantity 101 to the input of the adjusting device 300 for recognizing a jamming situation. Circuit arrangement (SA) for the electrical control and/or regulation of the movement of an electrically driven unit (2), in particular of a window winder or a sunroof or a seat adjustment device of a motor vehicle, comprising an acquisition unit (1) for measuring a correlation quantity (K) for the adjusting force

1-30. (canceled)

31. A method for controlling movement of an electrically driven unit (2) such as a window winder, a sunroof or a seat adjustment device of a motor vehicle, the method comprising:
determining a correlation quantity (K) for an adjusting force of the unit (2); and
in order to prevent jamming, an adjusting movement of the unit (2) is stopped or reversed depending on the value of the correlation quantity (K), wherein the correlation quantity (K) is temporarily filtered.

32. A method according to claim 31, wherein, depending on a quantity (122) characterizing the intensity of the alternating-signal components of the correlation quantity (K) or a quantity (103) characterizing the ripples in the voltage of the electrical supply system of the vehicle or a quantity (102) characterizing the speed (n) of the unit (2), a filtered correlation quantity (141) or an unfiltered correlation quantity (101) is used for the recognition of jamming situations.

33. A method according to claim 32, wherein at least one of an amplitude and a function of a high-pass-filtered or a band-pass-filtered input signal is used for determining the intensity of the alternating-signal component.

34. A method according to claim 33, wherein an alternating-signal component of the determined correlation quantity (K) or an alternating-signal component of the voltage (U_{B}) of the electrical supply system of the vehicle is determined.

35. A method according to claim 32, wherein the correlation quantity (K) is not filtered in the presence of a predetermined operating condition of the unit (2) or of the vehicle.

36. A method according to claim 31, wherein the adjusting movement of the unit (2) is stopped or reversed if a predetermined limiting value of the correlation quantity (K) is exceeded.

37. A method according to claim 31, wherein the motor current (I) is picked up for determining the correlation quantity (K) for the adjusting force.

38. A method according to claim 31, wherein the speed (n) of the unit (2) is determined for determining the correlation quantity (K).

39. A method according to claim 31, wherein at least one of the following or several parameters (P1 to Pn), the voltage (U_{B}) of the electrical supply system of the vehicle, the electrical resistance, the inductance, the temperature, the machine constant, the magnetic flux and/or a characteristic of the unit (2) are used for determining the correlation quantity (K).

40. A method according to claim 39, wherein the speed (n) is the basis for determining as to whether the recognition of a jamming situation is determined on the basis of an unfiltered correlation quantity (101) or of a filtered correlation quantity (141).

41. A method according to claim 31, wherein a voltage (U_{B}) of the electrical supply system of the vehicle is picked up and the amplitude or a function of the high-pass-filtered or band-pass-filtered voltage (U_{B}) of the electrical supply system of the vehicle is used for determining a quantity (103) characterizing the intensity of ripples in the voltage of the electrical supply system of the vehicle.

42. A method according to claim 31, wherein a quantity (103) characterizing the intensity of the ripples in the voltage of the electrical supply system of the vehicle is determined on the basis of the speed of the vehicle.

43. A method according to claim 31, wherein a state of the ignition system of the motor vehicle and/or the presence of the ignition key in the ignition lock is/are used for generating a quantity (103) characterizing the intensity of the ripples in the voltage of the electrical supply system of the vehicle.

44. A method according claim 31, wherein at least one of the state of the drive engine of the motor vehicle, and the speed signal of the drive engine of the motor vehicle are used for generating a quantity (103) characterizing the intensity of the ripples in the voltage of the electrical supply system of the vehicle.

45. A method according to claim 31, wherein a quantity (102) characterizing the rotor speed (n) is determined by determining the frequency of the alternating-signal components that are included in the unfiltered correlation quantity (101).

46. A method according to claim 31, wherein a maximum value of a certain number of input values is determined for determining the amplitude of the correlation quantity (K).

47. A method according to claim 31, wherein a mean power of a certain number of high-pass-filtered or band-pass-filtered input values is calculated for determining the function of the correlation quantity (K).

48. A circuit arrangement (SA) for electrical controlling movement of an electrically driven unit (2), such as a window winder, a sunroof or a seat adjustment device of a motor vehicle, the arrangement comprising:
an acquisition unit (1) for measuring a correlation quantity (K) for an adjusting force of the unit (2);
an adjusting device (300) for stopping or reversing an adjusting movement of the unit (2) depending on the value of the correlation quantity (K) in order to prevent jamming; and
a filter arrangement (100) for temporarily filtering the correlation quantity (K) is arranged between the acquisition unit (1) and the adjusting device (300).

49. A circuit arrangement according to claim 48, wherein the filter arrangement (100) comprises a filter (110, 210) for determining an alternating-signal component of the correlation quantity (K) and/or an alternating-signal component of the voltage (U_{B}) of the electrical supply system of the vehicle.

50. A circuit arrangement according to claim 49, wherein the filter (110, 210) is configured as a high-pass filter or a band-pass filter.

51. A circuit arrangement according to claim 48, wherein the filter arrangement (100) comprises a filter (140), such as a low-pass filter or a band-pass filter.

52. A circuit arrangement according to claim 48, wherein the filter arrangement (100) comprises a threshold comparator (130).

53. A circuit arrangement according to claim 52, wherein the unfiltered correlation quantity (101) is supplied to the filter (140) and to the alternating-signal filter (110).

54. A circuit arrangement according to claim 52, wherein the output signal of the alternating-signal filter (110) is supplied to an intensity-measuring device (120).

55. A circuit arrangement according to claim 54, wherein the output signal of the intensity-measuring device (120) is supplied to the threshold comparator (130).

56. A circuit arrangement according to claim 52, wherein a signal (102) characterizing the speed (n) of the rotor is supplied to the threshold comparator (130).

57. A circuit arrangement according to claim 52, wherein a signal (103) characterizing the intensity of the ripples in the voltage of the electrical supply system of the vehicle is supplied to the threshold comparator (130).

58. A circuit arrangement according to claim 52, wherein the output signal of the threshold comparator (130) determines a switch position of a switch (150).

59. A circuit arrangement according to claim 58, wherein the switch (150) in its position (S1) supplies the filtered correlation quantity (141) to the adjusting device (300).

60. A circuit arrangement according to claim 59, wherein the switch (150) in its position (S2) supplies the unfiltered correlation quantity (101) to the adjusting device (300).
